(19) United States
(12) Patent Application Publication
(10) Pub. No.: US 2025/0029511 A1
(43) Pub. Date: Jan. 23, 2025

(54) Systems and Methods for Customizing Generative Artificial Intelligence Based on User Engagement to Provide Individualized Education Curriculums

(71) Applicant: Stephen Cronan, Los Angeles, CA (US)

(72) Inventor: Stephen Cronan, Los Angeles, CA (US)

(21) Appl. No.: 18/775,141

(22) Filed: Jul. 17, 2024

Related U.S. Application Data
(60) Provisional application No. 63/514,253, filed on Jul. 18, 2023.

(51) Int. Cl. G09B 5/06; G06V 40/16; G09B 7/00; G10L 25/51

(52) U.S. Cl. CPC G09B 5/065; G06V 40/174; G09B 7/00; G10L 25/51

(57) ABSTRACT

An education platform has systems and associated methods for using generative artificial intelligence to generate and present individualized education curriculums based on tracked user engagement with the presented content. The education platform receives a request to provide individualized instruction to a user on a particular subject, and presents first content for a first part of the particular subject to the user. The education platform tracks user engagement with each of the first content using a set of sensors, and determines the user's learning preferences in response to tracking positive engagement that the user has with a subset of the first content of a first type, format, or presentation. The education platform customizes second content for a second part of the particular subject to have more content of the first type, format, or presentation than the first content based on the learning preferences.

### CLAIM OF BENEFIT TO RELATED APPLICATIONS

This application claims the benefit of U.S. provisional application 63/514,253,with the title “Systems and Methods for Customizing Generative Artificial Intelligence Based on User Engagement to Provide Individualized Education Curriculums”, filed Jul. 18, 2023. The contents of application 63/514,253 are hereby incorporated by reference

### BACKGROUND ART

Students learn at different paces, find different subject matter more interesting than others, and absorb information of a given subject matter differently depending on how it is presented. For instance, some students are visual learners, others learn through examples, others learn based on interactive dialog with the teacher or educator, others learn better in a quiet environment when they can think about the subject matter, and still others learn or absorb different subject matter according to other preferences.

Traditional classroom instruction proceeds at the singular pace of the educator (e.g., teacher, instructor, lecturer, presenter, etc.). The educator determines what content to present for a given subject matter, how to present that content, and at what pace to present the content. In other words, the subject matter is presented according to the preferences of the educator rather than the learning abilities or preferences of each student.

Online learn-as-you-go curriculums may provide greater flexibility by progressing through the subject matter based on the individual student's ability to grasp the subject matter. However, the subject matter remains the same for all students with the only change being the rate at which the subject matter is presented or the ability to skip over some of the subject matter if the student demonstrates an understanding of the subject matter. In other words, a visual learner is presented the same content as someone who learns better through interactive dialog with the educator.

Accordingly, there is need for a dynamic educational curriculum that adapts to the learning ability and/or preferences of each student. More specifically, there is need to provide different content to different students to maximize the information that each student retains and to maximize student engagement by adapting the content to the abilities and preferences of each student.

### BRIEF DESCRIPTION OF THE DRAWINGS

FIG. 1 illustrates an example education platform architecture in accordance with some embodiments presented herein.

FIG. 2 presents a process for providing individualized education curriculums that are customized based on user preferences determined from tracking user engagement in accordance with some embodiments presented herein.

FIG. 3 illustrates an example of generating a personalized learning model for a user based on user engagement in accordance with some embodiments presented herein.

FIG. 4 illustrates an example of customizing content for a lesson based on real-time monitoring of user engagement and dynamically determined user preferences in accordance with some embodiments presented herein.

FIG. 5 illustrates an example of dynamically customizing content of the same lesson for different users based on different tracked preferences in the personalized learning models of the different users in accordance with some embodiments presented herein.

FIG. 6 illustrates an example of training the education platform to generate customized content presentation for certifying educational advancement according to requirements set forth by one or more educational bodies in accordance with some embodiments presented herein.

FIG. 7 presents a process for a reverse training of the custom content generated for certifying education advancement based on the requirements set forth by one or more educational bodies in accordance with some embodiments presented herein.

FIG. 8 illustrates an example of educating students based on the custom content generated by the education platform and human intervention when needed in accordance with some embodiments presented herein.

FIG. 9 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Disclosed are systems and associated methods for customizing generative artificial intelligence (AI) based on user engagement to provide individualized education curriculums. The systems and methods provide a dynamic and autonomous education platform that adapts presented content on a given subject according to the learning abilities and/or preferences of each student.

The education platform uses generative AI to customize the content and/or to generate new and different content on the same subject for different users. The generative AI may customize the content based on signals of user engagement that the education platform monitors or tracks for each user while each user engages with the education platform and/or based on a real-time assessment or evaluation of each user's understanding of the previously presented content.

Customizing the content includes changing the presentation and form of the content, the pace at which the content is presented, the number of examples that are presented, the interaction with the user (e.g., numbers of questions that are asked, the voice and tone at which it is presented, etc.), the complexity of the content, and/or other changes to the content itself or the manner with which it is presented. In other words, the education platform dynamically changes the content and the presentation of the content for a selected subject matter on an individualized basis based on feedback collected from each user in order to maximize student engagement and maximize retention of the selected subject matter.

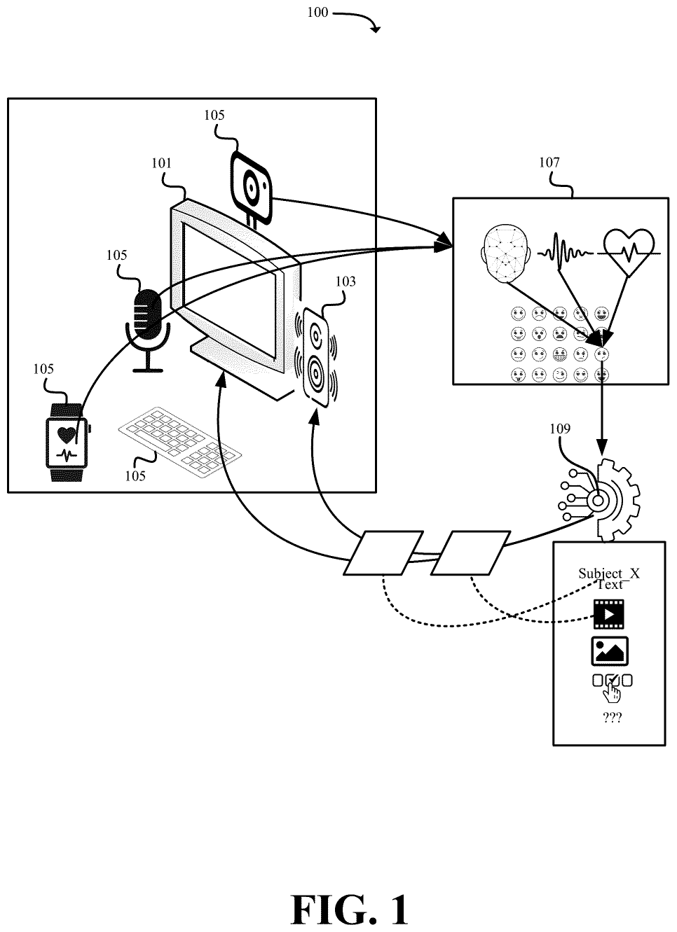

FIG. 1 illustrates an example education platform 100 architecture in accordance with some embodiments presented herein. Education platform 100 is a system of two or more computing devices or machines that communicate over a data network to generate the custom educational content in response to real-time tracking and evaluation of user engagement. Education platform 100 includes display 101, speakers 103, sensors 105, engagement tracker 107, and dynamic content generator 109.

Display 101 and speakers 103 present content in the form of text, images, videos, and/or sounds. Display 101 and speakers 103 may be part of a device that includes network connectivity for receiving the dynamically generated or customized content from dynamic content generator 109. For instance, display 101 and speakers 103 are part of a user computing device (e.g., desktop computer, tablet, smart phone, set top box, gaming appliance, virtual reality, augmented reality, or mixed reality headset, etc.) that connects to and/or integrates with education platform 100 to present the customized content to one or more users.

Sensors 105 monitor signals associated with user engagement. Sensors 105 may include one or more cameras, microphones, thermometers, motion trackers, and/or other monitoring devices. In some embodiments, the monitoring devices make contact with the user's body. For instance, sensors 105 may include activity trackers or wearable devices that track the user's heart rate, blood pressure, body temperature, oxygen levels, sleep, and/or other indicators of health or bodily state. The cameras and motion trackers may track facial expressions, body language, eye gaze, and/or gestures performed by a user. The microphones may acquire sound spoken by the user as well as sound from the surrounding environment.

Sensors 105 may monitor environmental signals as part of assessing user engagement. The environmental signals may include data about a user's learning environment. For instance, the environmental signals may identify lighting conditions, nosiness, temperature, time-of-day, and/or devices used by the user (e.g., mobile device versus a desktop computer).

Sensors 105 may also include input devices such as keyboards, mice, trackpads, and the like. Input tracked from the input devices may be used to determine user activity, responsiveness, attentiveness, and/or other measures of user engagement. For instance, the speed with which a user responds to a prompt and/or the speed at which a user provides input relative to their average speed may be used to derive one or more measures of user engagement.

Output from sensors 105 are provided to engagement tracker 107. In some embodiments, engagement tracker 107 and sensors 105 are integrated or part of the same device as display 101 and speakers 103. In some embodiments, engagement tracker 107 is located remote from sensors 105, and receives the output from sensors 105 over a data network. For instance, different instances of engagement tracker 107 may execute on one or more remote servers with each instance receiving user engagement signals or sensor 105 output for different users that are actively engaged with the education system.

Engagement tracker 107 includes processing, memory, storage, network, and/or hardware resources that receive and convert the signals from sensors 105 into measures or classifications of user engagement. In some embodiments, engagement tracker 107 performs sentiment analysis on the images that are acquired from the cameras and/or on the sound that is acquired from the microphones. In some such embodiments, engagement tracker 107 analyzes facial expressions and body language to classify the user as happy, bored, interested, tired, focused, distracted, energetic, enthusiastic, lethargic, frustrated, angry, confused, etc. Similarly, engagement tracker 107 analyzes pitch, tone, and/or other sound characteristics to derive additional measures of the user engagement. Other output from sensors 105, including heart rate, blood pressure, oxygen levels, speed at which input is provided on an input device, etc. may also be used to quantify and/or measure the user engagement as happy, bored, interested, tired, focused, distracted, energetic, enthusiastic, lethargic, frustrated, angry, confused, etc. In some embodiments, engagement tracker 107 outputs a numerical value that quantifies the user engagement based on the sensor 105 output.

Engagement tracker 107 may continually evaluate and/or classify the user engagement and may link the classifications to the content or type of content that was presented at the time of the classification. For instance, engagement tracker 107 may classify the user as bored when presented with specific textual content and may classify the user as interested when presented with a video or an image. Moreover, the classifications may be linked to a pace at which the content is presented (e.g., fast, medium, slow, etc.), the complexity of the content (e.g., basic, medium, advanced, simple words, complex words, short sentences, compound sentences, etc.), and/or other variations to the format and presentation of the content. In some embodiments, the classifications may be timestamped to align with timestamps at which different custom content is presented to a user in an audio and/or video stream.

Dynamic content generator 109 may contain content for teaching different subject matter and may include one or more processor, memory, storage, network, and/or other hardware resources for generating or customizing content from the stored content according to user preferences that are derived from the tracked user engagement. Specifically, dynamic content generator 109 may store different presentations or representations for the same content. For instance, the different presentations may include a textual representation, a diagram, a sound clip, a video clip, and/or an interactive interface that present the same content in different forms. Dynamic content generator 109 may include a generative AI system for selecting the content to present or for dynamically generating content based on the user engagement determined by engagement tracker 107. In some embodiments, dynamic content generator 109 may adjust the presentation of the selected content based on the user engagement. For instance, dynamic content generator 109 adjusts the pace at which the selected content is presented and/or pauses the presentation of the content to ask questions.

In some embodiments, the generative AI system dynamically generates the customized content based on the user engagement. For instance, education platform 100 may configure dynamic content generator 109 to generate content on a particular subject matter. Dynamic content generator 109 trains the generative AI system on the particular subject matter using base materials that May include text and images from a textbook on the particular subject matter and/or different textbooks on the particular subject matter for different grade levels. The generative AI system may query external sources for additional content on the particular subject matter or alternative representation of the content. The external sources may include network-accessible sites that contain videos, audios, images, and/or text on the particular subject matter that may be used to supplement or enhance the content from the provided training materials. For instance, the training materials may textually reference a particular person, location, or event, and generative AI system may scan the external sources for videos or images of the particular person, location, or event.

Also, depending on the user engagement or classifications tracked by sensors 105 and engagement tracker 107, dynamic content generator 109 may generate customized content for the particular subject matter by mixing-and-matching, reformatting, or otherwise modifying the content that was received for the particular subject matter. The user engagement corresponds to the sentiment, feedback, response, tone of voice, emotional state, and/or other input determined by engagement tracker 107 from monitoring the user. For instance, the user engagement may indicate that the user is confused. In response, the generative AI component may generate content that provides examples for the last presented content or may simplify the content. Alternatively, the user engagement may indicate that the user is distracted or disinterested, and the generative AI component may generate content that includes more visuals or interactivity with the user.

Dynamic content generator 109 may also generate a virtual presenter that is animated with human gestures and movements to present the customized content to the user. The virtual presenter may be generated according to the tracked user engagement and/or preferences for the virtual presenter that are derived from the tracked user engagement. In particular, dynamic content generator 109 may alter the speaking voice of the virtual presenter and the visual appearance of the virtual presenter to match a speaking voice and visual appearance that maximizes the user engagement and/or retention of the custom content. For instance, some users may prefer or learn better from a strict and formal tone while other users may prefer or learn better from a playful and informal tone. Similarly, some users may prefer or learn better from a virtual presenter with a human form while other users may prefer or learn better from a cartoony character.

Education platform 100 continually monitors the user engagement to customize the presented content throughout each session with a user. Specifically, education platform 100 continually monitors the user's reaction to the different presented content to determine the content type, format, presentation, and/or properties that is most interesting to the user or that keeps the user's attention and focus. In some embodiments, education platform 100 may construct a personalized learning model for each user. The personalized learning model represents the learning profile of a user and the most effective means for communicating information to the user. For instance, the personalized learning model may track the pace at which the user best absorbs information, the type of content or presentation format that most effectively conveys the information to the user, and/or the amount of interactivity, examples, images, videos, and/or questions that maximizes the user's retention of the presented information. Stated differently, the personalized learning model stores the user's learning preferences that are determined based on the tracked user engagement with different presented content types, formats, representations, styles, etc.

Education platform 100 may use the personalized learning model to customize the content and the presentation of content for subsequent sessions, the teaching of different subject matter, and/or as the user progresses through a given subject matter. In some embodiments, the personalized learning model may also track the difficulty level at which to present subject matter to a user. For instance, education platform 100 may determine that the user engages with and absorbs the content best when it is presented with wording, sentence structure, visual guides, pacing, and/or other formatting associated with a 10 year old versus a 12 year old despite the user being 12 years old.

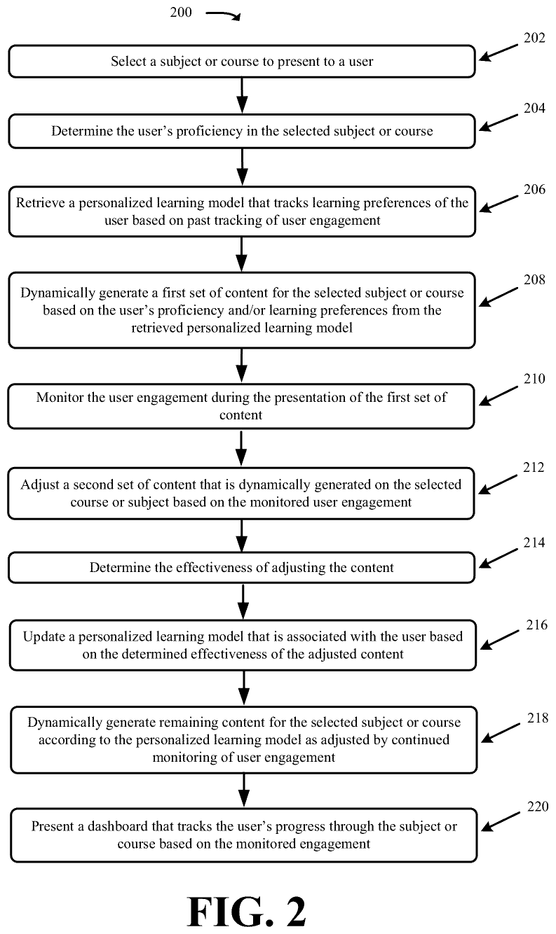

FIG. 2 presents a process 200 for providing individualized education curriculums with generative AI that is customized based on user preferences determined from tracking user engagement in accordance with some embodiments presented herein. Process 200 is implemented by education platform 100 and/or coordinated operation and control over display 101, speakers 103, sensors 105, engagement tracker 107, and dynamic content generator 109.

Process 200 includes selecting (at 202) a subject or course to present to a user. For instance, the user may select a particular mathematics (e.g., algebra, geometry, calculus, etc.), science, history, language, computer programming, or other subject matter to present to the user. Besides education, education platform 100 may be used for worker training, improving worker productivity, improving performance and/or effectiveness of sales agents or customer support personnel, and/or other activities involving the transfer of knowledge to the user.

Process 200 includes determining (at 204) the user's proficiency in the selected (at 202) subject or course. Education platform 100 may track the user's progression in each subject or course over time in order to determine what subject matter has been covered and what remains to be covered. The user proficiency may be based on the speed or rate at which the user progressed through past subjects or courses and/or test results that track how much of the past subjects or courses the user retained. In some embodiments, the user's proficiency may be tracked in the personalized learning model. In some embodiments, the user's proficiency may be determined (at 204) based on a set of questions presented about the subject or course to the user. For instance, education platform 100 may ask the user their age, their educational level, and/or what courses the user has previously completed on the subject. In some embodiments, education platform 100 presents a set of test questions on the selected subject or course to determine (at 204) the user's proficiency based on the number of questions that the user answers correctly or incorrectly. In some embodiments, education platform 100 determines (at 204) the user's proficiency holistically and continually based on user performance on home assignments, essays, forum discussions, tests, etc. In some embodiments, education platform 100 presents a questionnaire for ascertaining the user's learning style. For instance, the questionnaire may ask the user if they prefer more or less examples, more or less images, a lecturing style or question-and-answer style, hands-on learning versus demonstrative learning, desired pace of learning, difficulty level, and other customizable settings or preferences for the presentation of the subject or course subject matter.

Process 200 includes retrieving (at 206) a personalized learning model that is created for the user and that tracks learning preferences of the user based on past tracking of user engagement. The personalized learning model may specify whether the user is a visual learner, learns through examples, learns better with interactive dialogue, and/or other methods. More specifically, the personalized learning model may track the type or mix of content (e.g., images, videos, text, questions, examples, lecture, story-based, etc.) the user finds most engaging and/or the user best retains or learns from, the rate at which to present content to the user in order to maximize the retention of the content, the speaking voice and appearance for the visual presenter that the user finds most engaging, the number of examples and/or questions that maximize the user's retention of the content, the preferred complexity at which to present the content, and/or other preferences that maximize the user engagement and information retention.

Process 200 includes dynamically generating (at 208) a first set of content for the selected (at 202) subject or course based on the user's proficiency and/or learning preferences from the retrieved (at 206) personalized learning model. Dynamically generating (at 208) the first set of content includes selecting content on the selected (at 202) subject or course at the level of the user's proficiency. For instance, education platform 100 may use simpler words and sentences to present the same subject to a child than to an adult. Dynamically generating (at 208) the first set of content also includes customizing the presentation or format of the content according to the learning style or preferences of the user. For instance, the content may be customized to have more interactive examples to present a particular subject to a child and more text and diagrams when presenting the particular subject to an adult. Similarly, the content may be customized with more images and diagrams for a first student of a particular age or grade level associated with a personalized learning model indicating that the first student is a visual learner, and the content may be customized with more pauses and questions for a second student of the particular age or grade level associated with a personalized learning model indicating that the second student learns better one-on-one or with interactive dialogue. The content may also be customized with more or less questions, tests or quizzes, interactive simulations, collaborative assignments, visuals, text, open discussion, lectures, storytelling, or factual presentation.

The first set of content may be generated (at 208) for a specified period of time or amount of subject matter. For instance, education platform 100 may generate (at 208) the first set of content to cover a one minute period of time after which the next set of content may be customized based on monitored or tracked user engagement with the first set of content or entirety of the content that has presented over the current session.

In some embodiments, education platform 100 may generate (at 208) the first set of content to accommodate users with different disabilities. For instance, the first set of content may include subtitles or may be presented through sign language for users with a hearing disability. Moreover, education platform 100 may generate (at 208) the first set of content in any of several different supported languages. A language converter may be used to convert the first set of content from English to Spanish for users that are more comfortable with the Spanish language.

Process 200 includes monitoring (at 210) the user engagement during the presentation of the first set of content. Education platform 100 acquires images, sounds, inputs, and/or biomechanical feedback from sensors 105 to determine the user's emotional state, attentiveness, alertness, responsiveness, and/or other indicators as to the user's reaction to and/or engagement with the presented materials. For instance, education platform 100 may determine if a user is focused or distracted based on eye blink rate (e.g., is the user blinking frequently or infrequently), eye gaze (e.g., is the user staring at display 101 or is frequently looking away), heart rate, how fast the user responds to a prompt, and a sentiment analysis of the user speech (e.g., excited or bored pitch) and facial and body expressions. Monitoring (at 210) the user engagement may also include analyzing environmental signals such as lighting, noise, and/or temperature to determine the learning conditions preferred by the user or that keep the user focused on the presented content.

Education platform 100 may also monitor (at 210) the user engagement based on differently formatted questions that education platform 100 poses to the user about the first set of content and the accuracy of the responses provided by the user. For instance, education platform 100 may ask the questions in a textual format, a multiple choice format, an audible question that requires an audible response, or other interactive format. The different formatted questions may be used to assess the user's retention of the first set of content and/or to assess the assessment format that the user finds most engaging or that best extracts the learned information from the user. For instance, some users may find multiple choice questions confusing and select a wrong answer even though they retained the presented information. These users may better convey their understanding of the information by audibly explaining their answer to a question. Other users may have difficulty verbally expressing thoughts and may prefer writing their answers to a question or answering multiple choice questions to demonstrate their understanding of the information.

The monitored (at 210) user engagement may be combined with other measures of user engagement that are collected outside the presentation of the first set of content. For instance, the monitored (at 210) user engagement may be adjusted based on the frequency with which the user accesses the customized education platform and/or starts a lesson, activity patterns, and/or resource usage.

Process 200 includes adjusting (at 212) a second set of content that is dynamically generated on the selected (at 202) subject or course based on the monitored (at 210) user engagement. In response to the user engagement indicating that the user is focused, attentive, interested, and/or otherwise engaged, education platform 100 may generate the second set of content and present the second set of content in a similar format with a similar presentation and at a similar pace as the first set of content. In response to the user engagement indicating that the user is losing focus, lacks attention, is disinterested, and/or is otherwise disengaged, then education platform 100 may generate the second set of content and present it in a different format with a different presentation and/or pace than the first set of content.

The adjustments (at 212) that education platform 100 and/or dynamic content generators 109 may make to the content include generating the second set of content in a different format than the first set of content. For instance, education platform 100 may include modify the amount of text, diagrams, videos, audio, and/or interactivity that is provided with the second set of content to differ from the amount provided with the first set of content. The adjustments (at 212) may be based on user preferences identified in the personalized learning model. For instance, education platform 100 may increase the amount of images and videos used to convey the subject matter when the user is classified as a visual learner or is determined to prefer visual learning. Other adjustments (at 212) may include changing the difficulty of the content (e.g., word usage, sentence structure, amount of detail describing the subject, etc.), the pace at which it is presented (e.g., number of examples provided with an explanation of the subject matter, number of different descriptions provided to explain the subject matter, etc.), the frequency with which user input is requested (e.g., the number of test questions or quizzes posed to the user), and/or incorporation of current events. For instance, the user may become confused when too much jargon is used, terms unique to the subject are used, or complex words or longer sentences are used, and education platform 100 may generate the second set of content to reduce the jargon, reduce usage of unique terms, define terms more clearly, and/or use simpler words and shorter sentence to describe the subject matter. Similarly, education platform 100 may increase the speed at which the subject is presented to the user if the user loses focus at a slower pace of presentation, or may decrease the speed at which the subject is presented if the user becomes confused or loses focus at a faster pace of presentation. Other adjustments (at 212) include increasing or decreasing the number of examples given to explain the presented content, the types of examples (e.g., real-world examples or hypotheticals), the number of follow up questions that are asked after presenting the content, and/or the amount of interactivity required from the user.

Still other adjustments (at 212) that may be made to the content include changing the appearance, movements, gestures, mannerisms, and/or voice of a virtual presenter. For instance, dynamic content generators 109 may generate a virtual teacher with a human likeness and a male voice to present the generated content to the user. Education platform 100 may track how the user responds to the virtual presenter, and may determine that the appearance and/or voice of the virtual presenter does not hold the user's attention. Accordingly, education platform 100 may adjust (at 212) the second set of content to be presented by different virtual presenter or may change the vocal tone (e.g., stern to polite, informal to formal, etc.) and/or animated mannerisms of the virtual presenter. In some embodiments, education platform 100 may change the appearance of the virtual presenter from a human form to an animated form or the form of a historical person that is subject of the second set of content, or may change the voice of the virtual presenter from a male voice to a female voice or to the voice of the historical person that is the subject of the second set of content. In other words, dynamic content generators 109 may use the generative AI to change the format and presentation of the content as well as the AI-generated character and voice that are used to present the content to maximize the user attentiveness, engagement, and retention of the presented content. The generative AI may be trained to create deepfakes of the historical or important figures based on available audio and video of the historical or important figures.

The adjustments (at 212) may be made in real-time based on the user engagement and/or sentiment that is collected from the user in real-time. In some embodiments, the second set of content may include regenerating and presenting the first set of content at a different difficulty level when the engagement analysis reveals that the user is confused or did not comprehend the first set of content when it was presented. In some other embodiments, the second set of content may include progressing from the first set of content at a different difficulty level or with a different presentation format.

Process 200 includes determining (at 214) the effectiveness of adjusting (at 212) the content. Education platform 100 determines (at 214) the effectiveness of adjusting (at 212) the content by determining if the user engagement improves after presenting the second set of content. For instance, education platform 100 determines (at 214) if the user expressed signals of boredom or disinterest during the presentation of the first set of content and if the user expressed signals of interest and attentiveness during the presentation of the second set of content.

Process 200 includes updating (at 216) the personalized learning model that is associated with the user based on the determined (at 214) effectiveness of the adjusted content. Updating (at 216) the personalized learning model includes storing the types of content, presentation pace, complexity of content, amount of interactivity, examples, and questions, formatting of the content, and/or other preferences that peak the user engagement or that are determined to maximize the amount of information the user retains. Education platform 100 determines the preferences by identifying the type, format, presentation style, and/or other dynamically adjusted properties of content at times when the user engagement was determined to peak and/or by identifying the type, format, presentation style, and/or other dynamically adjusted properties of content related to test questions that the user answered correctly.

Process 200 includes dynamically generating (at 218) remaining content for the selected (at 202) subject or course according to the personalized learning model as adjusted by the continued monitoring of user engagement. The personalized learning model tracks the individualized learning preferences of the user including the type, format, presentation style, and/or other dynamically adjusted properties of content that are determined to keep the user engagement and that are determined to maximize the user's retention of the presented information.

Process 200 include presenting (at 220) a dashboard at the end of the subject, course, or lesson that tracks the user's progress through the subject or course based on the monitored engagement. For instance, the dashboard may identify the tracked user engagement with different content and/or at different times throughout the lesson and/or provides an assessment as to content that the user has mastered or has difficulty with based on answers or responses provided by the user or other interactivity observed from the user when the content was presented. The dashboard may be presented to the user, a parent, or an educator. Additional user input may be provided for customizing future lessons based on the data contained in the dashboard. For instance, an educator may review the dashboard and may change or add learning preferences to the personalized learning model of the user that education platform 100 accounts for when generating next content.

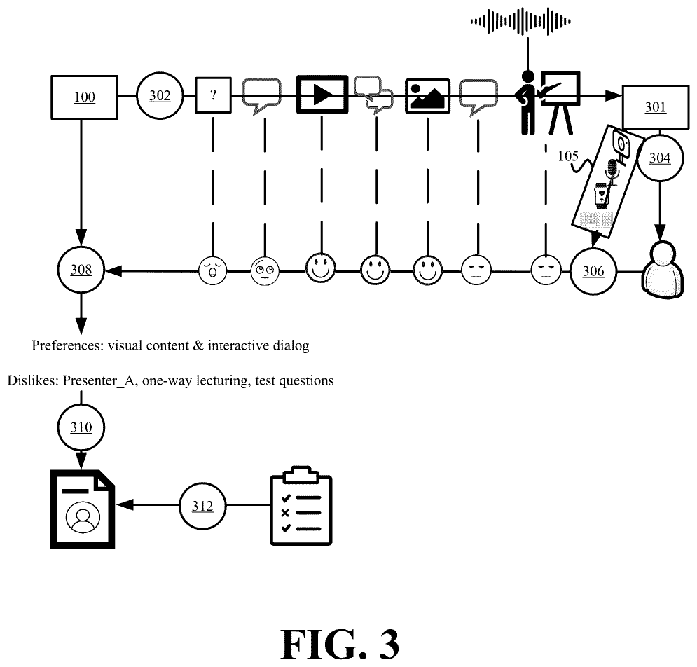

FIG. 3 illustrates an example of generating a personalized learning model for a user based on user engagement that is tracked by a set of sensors in accordance with some embodiments presented herein. Education platform 100 generates and transmit (at 302) first content for a particular subject with a first format and presentation to user device 301. The first format and presentation may include a first mix or amount of images, video, audio, interactive content, and text that explain the particular subject at a first rate with a first level-of-complexity. The first format and presentation may also include an AI-generated virtual presenter with a first appearance and a first voice for presenting the first content. The first content is transmitted (at 302) across a data network in response to a request from user device 301 to access education platform 100 and start or continue a lesson or course on the particular subject.

User device 301 presents (at 304) the first content to a user through a display, speaker, and/or other output devices. User device 301 uses sensors 105 to track (at 306) user engagement throughout the presentation (at 304) of the first content. Specifically, sensors 105 capture images of the user, user speech, body signals, environmental conditions, user input, and/or other indicators of user engagement with a timestamp or other association to the content that was presented (at 304) at the time of different tracked user engagement.

In some embodiments, education platform 100 receives the tracked (at 306) user engagement from user device 301, and locally executes engagement tracker 107 to process the sensor 105 output and/or the tracked (at 306) user engagement. In some other embodiments, engagement tracker 107 runs on user device 301 and processes the sensor 105 output and/or the tracked (at 306) user engagement using resources of user device 301.

Engagement tracker 107 may perform image analysis to detect facial expressions and body language of the user, sentiment analysis on the user speech, changes in the body signals, changes in the environment conditions, responsiveness or accuracy of the user input, or other changes to the indicators of user engagement that happen as the format or presentation of the first content changes.

Engagement tracker 107 determines parts of the first content where the user was interested, engaged, was otherwise actively participating, and/or retained after it was presented (e.g., correctly answered questions about, was able to explain in their words, and/or accurately repeated), and other parts of the first content where the user was disinterested, disengaged, was not actively participating, and/or did not retain by a threshold amount. In some embodiments, engagement tracker 107 identifies the times where the user expressed positive emotion or behavior to the format, presentation, and type of the content that was presented at those times, and also identifies the times where the user expressed negative emotion or behavior to the format, presentation, and type of the content that was presented at those times. The analysis performed by engagement tracker 107 is provided to education platform 100.

Education platform 100 determines (at 308) user preferences based on the different user engagement that is detected or tracked (at 306) when different types, formatting, presentations, and/or other differentiable content were presented (at 304) to the user. Specifically, education platform 100 determines (at 308) the user preferences by identifying repeating patterns in which the user engages with, shows interest in, or otherwise responds positively to specific types, formatting, presentations, and/or other differentiable content. Education platform 100 may also determine (at 308) other types, formatting, presentations, and/or differentiable content that the user does not engage with, is uninterested in, or otherwise responds negatively to.

Education platform 100 may generate (at 310) a personalized learning model for the user, and may store the determined (at 308) user preferences and/or dislikes of the user to the personalized learning model. The personalized learning model may include a profile, data structure, or file that stores the determined (at 308) user preferences or interests of the associated user. The personalized learning model may be linked or identified with a unique identifier of the user. For instance, the personalized learning model may be identified based on the user name, name and date-of-birth, and/or login information that the user uses to access education platform 100. Education platform 100 may segment or structure the personalized learning model to store different user preferences for different subjects. For instance, the personalized learning model may identify the user as a visual learner that prefers diagrams and images over text for science, and may identify that the user prefers numerous examples or questions for mathematics.

Education platform 100 may supplement (at 312) the personalized learning model with preferences that the user has provided by answering a questionnaire. The user-provided preferences may include a preferred learning style, a preferred content format, a preferred learning pace, a preferred difficulty level, and/or other user-specified preferences. The user-provided preferences may be obtained before the user begins a lesson or when the user registers with education platform 100.

Education platform 100, by execution of dynamic content generators 109, uses the personalized learning models to dynamically customize the content that is presented to a user over the course of a lesson and/or to dynamically customize the content for future lessons after a current lesson is completed. Specifically, dynamic content generators 109 customize the content according to the tracked user preferences in order to keep the user engaged throughout the lesson and maximize the information that the user learns and/or retains.

Education platform 100 may also supplement the personalized learning model with input provided by parents or teachers. Parents may enter learning disabilities (e.g., dyslexia) or behavioral challenges of a student that may affect the content that education platform 100 generates for that student.

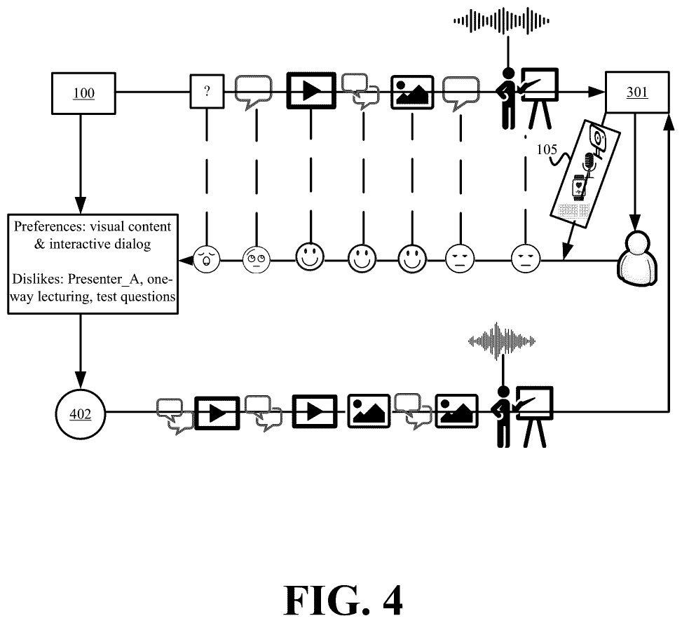

FIG. 4 illustrates an example of customizing content for a lesson based on real-time monitoring of user engagement and dynamically determined user preferences in accordance with some embodiments presented herein. FIG. 4 continues from the example of FIG. 3 by illustrating education platform 100 modifying the type, format, presentation, and/or other modifiable properties of the content according to the determined user preferences. In particular, education platform 100 generates (at 402) second content to teach the particular subject to the user based on the user preferences stored in the personalized learning model of the user. Education platform 100 generates (at 402) the second content to differ from the first content by changing the vocal tone and/or appearance of the virtual presenter, by including less one-way lecturing and more visual content, and by replacing written test questions with more interactive dialog and/or verbal back-and-forth with the user.

Education platform 100 creates an individualized learning experience by customizing the content according to different preferences of different users. As such, no two user may receive the same content when learning the same subject.

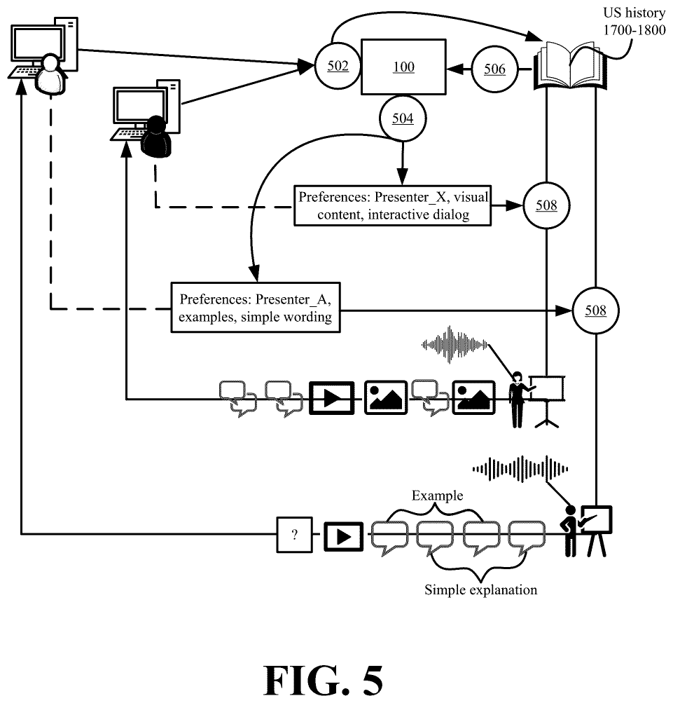

FIG. 5 illustrates an example of dynamically customizing content of the same lesson for different users based on different tracked preferences in the personalized learning models of the different users in accordance with some embodiments presented herein. Education platform 100 receives (at 502) a request from a first user device and a second user device for the same subject matter (e.g., the same information or material for the same part of the lesson). For instance, the first user device and the second user device may be associated with two students that are both starting a trigonometry lesson or a physics lesson about kinematics.

Education platform 100 retrieves (at 504) a personalized learning model that was generated based on tracked engagement of the users associated with the first user device and with the second user device. For instance, as part of issuing the requests to education platform 100, each user device may login to a user account that is associated with or linked to the personalized learning models of the different users.

Education platform 100 retrieves (at 506) the content for the requested lesson and/or subject matter. The retrieved (at 506) content may be sourced from an approved textbook or other source material (e.g., a teacher's lesson plan, a school curriculum, etc.).

Education platform 100 customizes (at 508) the content for each user of the requesting user devices based on the personalized learning model associated with that user. Customizing (at 508) the content may include changing the format or presentation of the content. In some embodiments, customizing (at 508) the content may include adding or removing images, videos, or other interactive content to include with a textual or verbal representation of the content. Education platform 100 may source the images, videos, or other interactive content from supplemental sources. For instance, the content may describe a historical figure or event, and education platform 100 may obtain videos of the historical figure or event from third-party video sites to present with the content from the original source materials.

Customizing (at 508) the content may include using generative AI to change the grammar and wording of the content. For instance, education platform 100 may simplify the wording and present the content with shorter sentences to a first user based on a first preference of the first user, and may extend the explanation of the content by adding examples for a second user based on a second preference of the first user. Customizing (at 508) the content may include modifying the content to engage in a back-and-forth dialog with the first user in which verbal questions are posed to the first user in order to ask the first user about their thoughts or to verbally answer questions about the presented content based on a third preference of the first user, and may include modifying the content to intersperse written test questions throughout the content presentation provided to the second user based on a fourth preference of the second user.

The customizations (at 508) may also include content gamification. For instance, education platform 100 may use generative AI to generate an interactive game in which a user controls an object or character to demonstrate certain aspects of the explained subject matter (e.g., velocity, first law of thermodynamics, etc.).

Customizing (at 508) the content may include changing the content presentation. For instance, education platform 100 may adjust the rate or pacing at which the content is presented to each user with a first user receiving more information in a given amount of time and with a second user receiving less information but with more examples or questions in the given amount of time based on different user learning preferences associated with each user. Changing the content presentation may also include changing the tone and visual appearance of different virtual presenters that are generated to present the same content to different users. For instance, the personalized learning model of the first user may indicate that the first user learns better and absorbs more information if presented by a female figure and/or female voice, and the personalized learning model of the second user may indicate that the second user learns better and absorbs more information if presented by a male figure and/or male voice. Accordingly, education platform 100 may feed the customized content selected for the first user and the second user into a generative AI system with the different presentation preferences, and the generative AI system may generate a female first virtual presenter that verbally recites the customized content selected for the first user in a simulated female voice (e.g., a first pitch, tone, frequency, etc.) and may generate a male second virtual presenter that verbally recites the customized content for the second user in a simulated male voice (e.g., a second pitch, tone, frequency, etc.). Similarly, the personalized learning models may indicate that the first user responds better to a polite presenter that makes infrequent eye contact and that the second user responds better to a stern or firm presenter that keeps eye contact on the student/user. The personalized learning models of children may indicate the children respond better to a cartoony character that has an animated form of animal preferred by each child.

Education platform 100 presents the customized content for the first user on the first user device and the customized content for the second user on the second user device. In particular, education platform 100 generates and transmits different audio and/or video streams with the different customized content to each user device. Education platform 100 monitors the user engagement through the user device sensors, and performs additional customizations as necessary to maximize user focus, interest, and engagement. For instance, in response to education platform 100 determining that the first user expresses confusion, disinterest, or incorrectly answers a question to recently presented information, education platform 100 may dynamically customize the content to present the same information in an alternative format rather than advance through the lesson to new information. The dynamic customization may including providing a visual example of the information or interactive content demonstrating the information in the real world.

Education platform 100 is trained according to different accreditations and/or educational standards. In particular, education platform 100 is trained to satisfy requirements of different educational bodies (e.g., school boards or districts, state or governmental educational departments, colleges, universities, independent or corporate training programs, etc.) and to provide automated instruction on behalf of the educational bodies. In other words, the information that is conveyed or taught by education platform 100 may certify user advancement through and/or completion of different degrees (e.g., Associate's degrees, Bachelor's degrees, Master's degrees, Doctorate degree, training certifications, accreditation programs, etc.) recognized by different educational institutions using education platform 100 as a substitute or supplement to live human instruction.

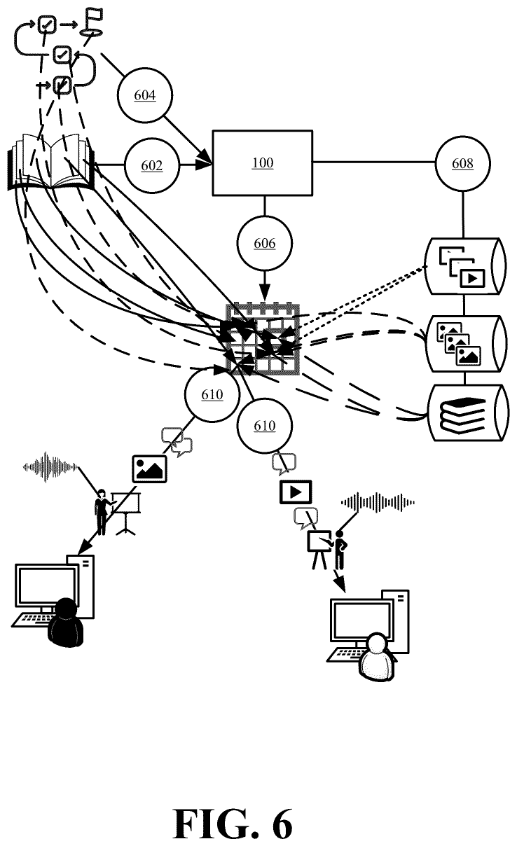

FIG. 6 illustrates an example of training education platform 100 to generate customized content presentation for certifying educational advancement according to requirements set forth by one or more educational bodies in accordance with some embodiments presented herein. As a particular example, FIG. 6 illustrates training education platform 100 for certifying student completion of a particular subject at a particular grade level (e.g., high school 10th grade United States history).

The training includes providing (at 602) one or more textbooks approved by the educational body as training data for education platform 100. For instance, a digital copy of the textbooks with the text and images may be fed into a neural network or machine learning model of education platform 100.

The training may further incorporate input from teachers or educators. Teachers or educators may specify (at 604) curriculum goals or milestones that should be reached in order to certify advancement through the subject matter. The goals or milestones may be defined in terms of specific proficiency that each user or student should demonstrate at different times or stages in the curriculum.

Education platform 100 parses and/or analyzes (at 606) the training data to formulate lessons. The parsing and/or analysis (at 606) may be conducted according to a specified number lessons and time that is allotted for each lesson. For instance, education platform 100 may have one hour sessions, three times a week, for ten weeks to teach users the particular subject at the particular grade level. Accordingly, the parsing and analysis (at 606) may include segmenting the training data into 30 lessons with each lesson focusing on new materials that are related on or based off the materials of past lessons. Education platform 100 may extract facts, explanations, examples, images, questions, and/or other data from the training data, and may store the extracted data in a structured format with labels that identify the data type (e.g., fact, explanation, example, image, etc.) and/or the topic or subject matter to which the data applies.

Education platform 100 supplements (at 608) the material of each lesson with related materials that are sourced from sources other than the textbooks provided as training data. For instance, education platform 100 may search the Internet for additional materials or different presentations of the same materials from trusted sites. The additional materials may include images, videos, audio, text, or interactive content describing topics identified in the training data. The different presentations of the same materials may include presentations of the same materials with simpler or more complicated language or descriptions, with fewer or more visual content, with fewer or more examples, and/or other manners with which the same materials are presented differently.

Supplementing (at 608) the material may include linking or associating the supplemental materials to the relevant subject matter from the parsed (at 606) training data. For instance, education platform 100 may generate data structures for different topics identified from parsing and analyzing (at 606) the source materials, may store the source materials for the identified topics into the corresponding data structures, and may add the supplemental materials for the identified topics into the corresponding data structures with classification labels.

The classification labels may rank the difficulty of the supplemental materials relative to the source materials, may specify the supplemental material type (e.g., supplemental visual content, supplemental examples, supplemental text, supplemental questions, etc.), and/or otherwise differentiate the supplemental materials relative to the source materials. In some embodiments, the labels may be associated with specific preferences from the personalized learning models. For instance, the supplemental materials may be classified as relevant to a visual learner, a user that prefers real-world examples, a user that prefers a basic or high-level presentation of the materials, a user that prefers an advanced or low-level presentation of the materials, etc.

Education platform 100 may generate (at 610) the customized content for the particular subject matter at the particular grade level by selecting between the source materials and the supplemental materials with labels matching user preferences in the user's personalized learning model. Additionally, education platform 100 may dynamically generate (at 610) the customized content for the particular subject at the particular grade level by entering the source materials and the supplemental materials with the user preferences into a generative AI system. The generative AI system may generate new materials based on the entered source materials and the supplemental materials. The generative AI system may reformat and/or change the presentation of the source materials and the supplemental materials according to the user preferences. For instance, the generative AI system may mix-and-match different source materials and supplemental materials to create the customized content, generate new explanatory text, examples, or questions based on the source materials and supplemental materials, may rewrite the text of the mixed-and-matched materials, and/or may generate audio and/or video by which a virtual presenter presents the customized content to the user according to the user preferences.

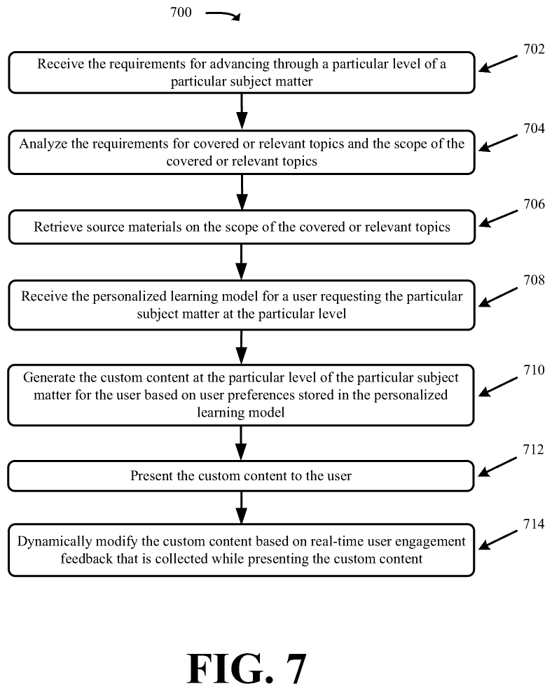

Other methods may be used to train education platform 100 for the custom content generation. FIG. 7 presents a process 700 for a reverse training of the custom content generated for certifying education advancement based on the requirements set forth by one or more educational bodies in accordance with some embodiments presented herein. Process 700 is implemented by education platform 100.

Process 700 includes receiving (at 702) the requirements for advancing through a particular level of a particular subject matter. For instance, education platform 100 may receive (at 702) separate requirements for certifying advancement of 4th grade math and 5th grade math, and/or may receive (at 702) separate requirements for certifying advancement of a first physics course and a second physics course. In some embodiments, the requirements are represented through a standardized examination or a set of test questions, and satisfaction of the requirements includes a student achieving a minimal mark on the standard examination or answering a threshold number of the set of test questions correctly. Accordingly, receiving (at 702) the requirements may include receiving different sets of test questions for evaluating user proficiency for the particular level of the particular subject matter, and different thresholds associated with each set of questions. The test questions may be drafted by a teacher or educational body responsible for educational certification and/or accreditation. In some embodiments, the requirements are defined by educators and specify certain quantifiable goals or milestones that different students are to achieve in order to advance through a particular level of a particular subject matter.

Process 700 include analyzing (at 704) the requirements for covered or relevant topics and the scope of the covered or relevant topics. For instance, the requirements may cover elementary school addition and subtraction, and analyzing (at 704) the requirements may include determining that the requirements cover single and two digit addition and subtraction (e.g., does not include three or more digit additional and subtraction or the addition and subtraction of fractional values). Similarly, the requirements may cover American history, and analyzing (at 704) the requirements may include determining that the requirements cover wars and the American economy between 1800 and 1900 (e.g., does not cover American politics or American foreign relations in that time). Analyzing (at 704) the requirements may include searching for specific keywords, symbols, and/or expressions.

Process 700 includes retrieving (at 706) source materials on the scope of the covered or relevant topics for the received (at 702) requirements. In some embodiments, education platform 100 retrieves (at 706) the source materials from a list of approved textbooks or teaching materials. For instance, the educational body defining the requirements may provide the list of approved textbooks or teaching materials, and education platform 100 may search through digital copies of the list of approved textbooks or teaching materials in order to identify and extract the source materials on the scope of the covered or relevant topics. In some embodiments, education platform 100 retrieves (at 706) the source materials from searching sites across the Internet and/or information repositories with trusted information and/or by verifying source materials collected from different sites or sources against one another. For instance, if the source materials collected from different sites contradict one another or provide divergent information, education platform 100 may exclude or discard those source materials. However, if the source materials collected from two or more different sites match or are similar to one another, then education platform 100 may retrieve (at 706) and store the source materials. In any case, education platform 100 compiles the source materials for teaching or conveying the information for the particular level of the particular subject matter so that the source materials may be varied and comprehensive.

Process 700 includes receiving (at 708) the personalized learning model for a user that requests the particular subject matter at the particular level. The personalized learning model of the user may be accessed in response to user logging in, requesting, or continuing a lesson on the particular subject matter at the particular level.

Process 700 includes generating (at 710) the custom content at the particular level of the particular subject matter for the user based on user preferences stored in the personalized learning model. In some embodiments, generating (at 710) the custom content may include selecting a subset of the retrieved (at 706) source materials for presenting the particular subject matter according to preferences of the user that are specified in the personalized learning model. In some embodiments, generating (at 710) the custom content may include entering the user preferences from the personalized learning model and the retrieved (at 706) source materials into a generative AI system, and receiving the custom content that is generated by the generative AI system. The generative AI system may rewrite, add new content, format, and/or generate a custom presentation of the source materials according to the user preferences. For instance, the generative AI system may add questions or interactions to determine whether the user has a proper understanding of the earlier presented custom content. The generative AI system may also create a virtual presenter to verbally and/or visually present the custom content. For instance, the virtual presenter may include a digitally created instructor that is animated with different expressions and mannerisms to increase or induce user engagement with different parts of the custom content.

Process 700 includes presenting (at 712) the custom content to the user. Presenting (at 712) the custom content may include presenting the audio and/or video streams that are generated for the custom content to the user device, and measuring user engagement with sensors of the user device while the custom content is being presented. User engagement may also be measured based on responses that the user provides when asked different questions or based on responses that the user provides when prompted during the presentation of the custom content.

Process 700 includes dynamically modifying (at 714) the custom content based on real-time user engagement feedback that is collected while presenting (at 712) the custom content. Dynamically modifying (at 714) the custom content may include adjusting the content format or presentation to increase or improve user engagement. For instance, education platform 100 may add more images or video content if the user appears bored or looking away from the display when only text or audio is presented, may provide more examples if the user appears confused or is not focused after certain information is presented, and may provide more interactivity or request more user involvement if the user is distracted. Dynamically modifying (at 714) the custom content may also include changing the pace or rate at which the custom content is presented or the mannerisms and verbal tone of the virtual presenter based on the user engagement feedback.

Education platform 100 may operate as an independent or stand-alone instructional system for students that may have difficulty with traditional classroom settings and/or instruction, that do not learn effectively without one-on-one interaction, or that prefer to learn at their own schedule or pace. Education platform 100 may also operate to supplemental or improve traditional classroom instruction. Specifically, smaller classroom sizes and smaller student-to-teacher ratios have proven to result in better education. However, some schools do not have the resources to hire more teachers or cannot find qualified, trained, and/or experienced teachers for certain subject matter. Accordingly, education platform 100 may lessen the burden on human teachers by providing the foundational instruction on a customized basis to students and supplementing that foundational instruction with one-on-one or small group assistance from a human teacher for those students that need additional help or are having difficulty with specific portions of the subject matter as presented by education platform 100.

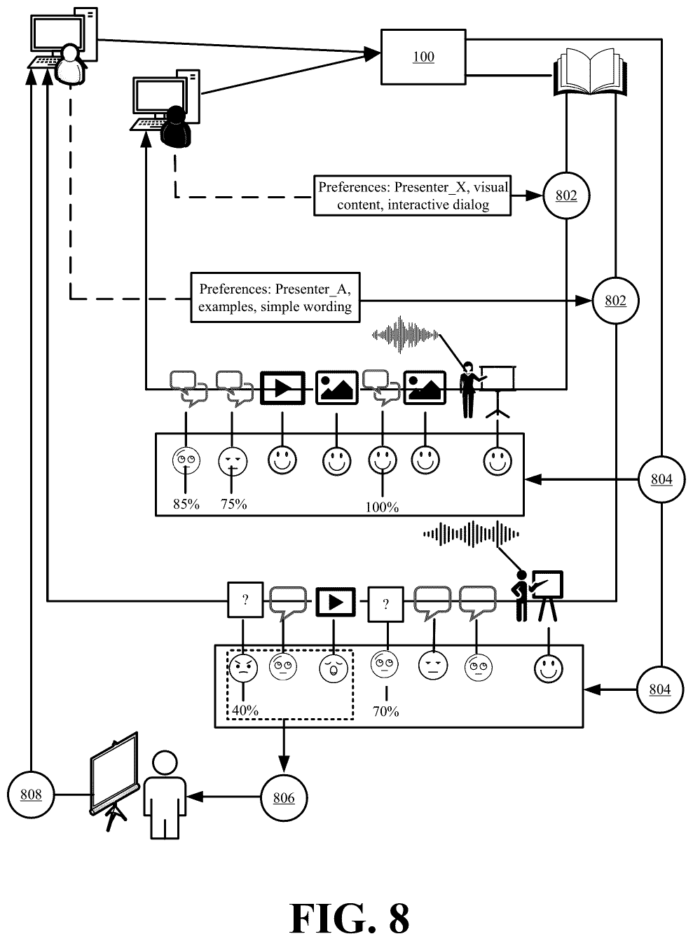

FIG. 8 illustrates an example of educating students based on the custom content generated by education platform 100 and human intervention when needed in accordance with some embodiments presented herein. Education platform 100 generates and presents (at 802) content that is customized on an individualized basis to teach a particular subject to a group of students. In particular, education platform 100 changes the format and presentation of the content as well as the content itself to present the content that matches the preferences of each individual student and to maximize student engagement and retention of the particular subject.

Education platform 100 assesses (at 804) each student's understanding of the presented (at 802) content. The assessment (at 804) is performed based on the sensor-based tracking of the user engagement and testing of the student's retention of the content. For instance, the sensor-based tracking detects user sentiment and behavior throughout the presentation of the custom content to ascertain the level of user engagement and/or interest. The testing of the student's retention may be evaluated based on the accuracy of answers that the student provides to questions about the presented (at 802) content and/or based on the detail with which the student is able to verbally explain or repeat the content.

The results of the assessment (at 804) may be presented to educators, parents, or students. For instance, education platform 100 may generate a user interface that presents grades, scores, or levels-of-mastery for different subject matter or content that was presented to the student.

Education platform 100 detects (at 806) a particular student that has difficulty learning part of the subject based on the assessment (at 804) and different attempts to customize the content for better engagement and/or retention by the particular student. For instance, education platform 100 detects (at 806) the particular student having difficulty in response to detecting continued frustration, disinterest, and/or other signals of disengagement from the particular student despite different attempts to customize the content to preferences of the particular student and further in response to the particular student scoring below a threshold when evaluating the particular student's understanding of the subject matter with test questions or dialog.

Education platform 100 connects (at 808) a human teacher to tutor or assist the particular student in learning or reviewing the part of the lessor or subject matter that the particular student has difficulty with. Connecting (at 808) the human teacher to the particular student may include providing the human teacher with the assessment results that identify the subject matter or content that the particular student has difficulty with. In some embodiments, education platform 100 connects (at 808) the particular student to the human teacher by joining the devices of the particular student and the human teacher to a private conference. The human teacher may directly engage the particular student with alternative teaching methods that differ from the instruction provided by education platform 100.

Education platform 100 may continue monitoring the group of students, and may later detects second and third students that have difficulty learning a second topic of the subject. Education platform 100 may connects the human teacher to the smaller group of the second and third students once the human teacher has completed assisting the particular student. Accordingly, education platform 100 connects the students to a live teacher on an on-demand or as-needed basis. This allows the live teacher to more directly or personally assist a larger number of students than in a traditional classroom setting where the live teacher has to progress through the subject matter in the classroom allotted time even if one or more students fall behind and fail to grasp the subject matter.

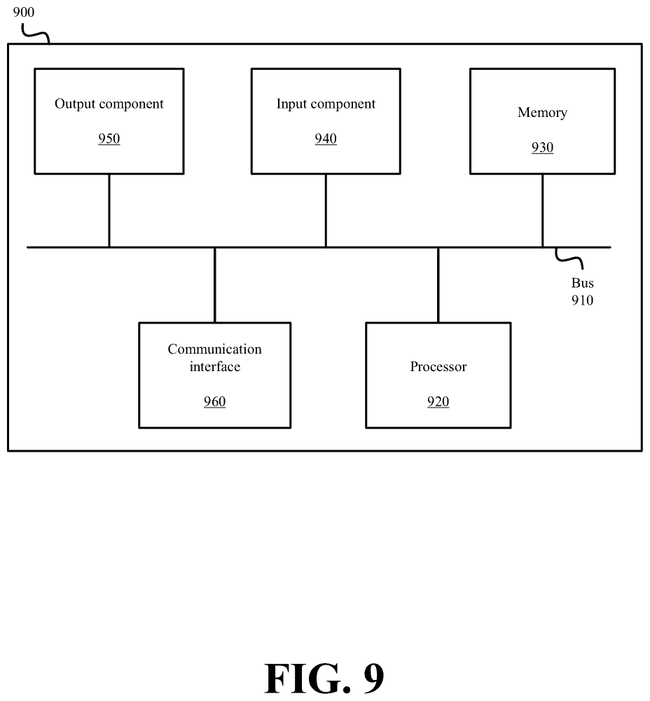

FIG. 9 is a diagram of example components of device 900. Device 900 may be used to implement one or more of the tools, devices, or systems described above (e.g., education platform 100, engagement tracker 107, dynamic content generator 109, generative AI system, etc.). Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more LEDs, etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving a request to provide individualized instruction to a user on a particular subject;
presenting a first set of content associated with a first part of the particular subject to the user;
tracking engagement that the user has with each content from the first set of content using a set of sensors;
determining learning preferences of the user in response to tracking positive engagement that the user has with a subset of content in the first set of content of a first type, a first format, or a first presentation;
customizing a second set of content associated with a second part of the particular subject to differ from the first set of content based on the learning preferences of the user, wherein customizing the second set of content comprises selecting more content of the first type, the first format, or the first presentation for the second set of content than is included in the first set of content; and
presenting the second set of content to the user.

2. The method of claim 1, wherein tracking the engagement comprises:
analyzing facial expressions and voice sentiment when the user is presented with each content from the first set of content; and
classifying the engagement with each content based on the facial expressions and the voice sentiment.

3. The method of claim 1, wherein customizing the second set of content comprises:
presenting a different ratio of images and videos with the second set of content than with the first set of content.

4. The method of claim 1, wherein customizing the second set of content comprises:
modifying a complexity of words used to explain the particular subject with the second set of content relative to a complexity of words used to explain the particular subject with the first set of content.

5. The method of claim 1, wherein customizing the second set of content comprises:
increasing a number of examples that are provided with the second set of content than with the first set of content based on the learning preferences indicating the positive engagement with examples.

6. The method of claim 1, wherein customizing the second set of content comprises:
changing between a first format of evaluating user understanding of the particular subject in the first set of content to a second format of evaluating user understanding of the particular subject in the first set of content in response the learning preferences indicating a negative engagement with the first format.

7. The method of claim 1 further comprising:
retrieving a plurality of base content on the particular subject; and
wherein customizing the second set of content comprises:
dynamically generating the second set of content by changing one or more of a type, format, or presentation style with which a subset of the plurality of base content is presented to the user.

8. The method of claim 1 further comprising:
generating a virtual presenter with an animated human form that speaks various content from the second set of content.

9. The method of claim 1 further comprising:
generating a video stream of a virtual presenter with a human form to present various content from the second set of content; and
generating an audio stream of a human voice for audibly reciting text associated with the various content.

10. The method of claim 1 further comprising:
extracting a plurality of source content on the particular subject from a digital copy of an approved textbook;
supplementing the plurality of source content with supplemental content from a plurality of external sources, wherein the supplemental content comprises images, videos, and additional text for topics referenced in the plurality of source content;
wherein presenting the first set of content comprises presenting a first amount of content from the plurality of source content and the supplemental content to the user; and
wherein customizing the second set of content comprises selecting a second amount of content from the plurality of source content and the supplemental content, wherein the second amount of content includes less content from the plurality of source content and more content from the plurality of source content than the first set of content.

11. The method of claim 1 further comprising:
receiving a request to provide individualized instruction to a second user on the particular subject, wherein the second user is different than the user; and
presenting a third set of content associated with the first part of the particular subject to the second user based on the second user being associated with different learning preferences than the user.

12. The method of claim 1 further comprising:
retrieving a personalized learning model of the user in response to the request; and
customizing the first set of content according to a first set of learning preferences stored in the personalized learning model.

13. The method of claim 12 further comprising:
updating the personalized learning model in response to tracking the engagement that the user has with each content of the first set of content, wherein updating the personalized learning model comprises changing the first set of learning preferences to a second set of learning preferences to include learning preferences that are derived from the positive engagement.

14. An education platform comprising:
a system with one or more hardware processors configured to:
receive a request to provide individualized instruction to a user on a particular subject;
present a first set of content associated with a first part of the particular subject to the user;
track engagement that the user has with each content from the first set of content using a set of sensors;
determine learning preferences of the user in response to tracking positive engagement that the user has with a subset of content in the first set of content of a first type, a first format, or a first presentation;
customize a second set of content associated with a second part of the particular subject to differ from the first set of content based on the learning preferences of the user, wherein customizing the second set of content comprises selecting more content of the first type, the first format, or the first presentation for the second set of content than is included in the first set of content; and
present the second set of content to the user.

15. The education platform of claim 14 further comprising:
a user device that is communicably coupled to the system, the user device comprising:
a speaker;
a display; and
the set of sensors.

16. The education platform of claim 14, wherein tracking the engagement comprises:
analyzing facial expressions and voice sentiment when the user is presented with each content from the first set of content; and
classifying the engagement with each content based on the facial expressions and the voice sentiment.

17. The education platform of claim 14, wherein customizing the second set of content comprises:
presenting a different ratio of images and videos with the second set of content than with the first set of content.

18. The education platform of claim 14, wherein customizing the second set of content comprises:
modifying a complexity of words used to explain the particular subject with the second set of content relative to a complexity of words used to explain the particular subject with the first set of content.

19. The education platform of claim 14, wherein customizing the second set of content comprises:
increasing a number of examples that are provided with the second set of content than with the first set of content based on the learning preferences indicating the positive engagement with examples.

20. A non-transitory computer-readable medium storing instructions that, when executed by one or more processors of an education platform, cause the education platform to perform operations comprising:
receiving a request to provide individualized instruction to a user on a particular subject;
presenting a first set of content associated with a first part of the particular subject to the user;
tracking engagement that the user has with each content from the first set of content using a set of sensors;
determining learning preferences of the user in response to tracking positive engagement that the user has with a subset of content in the first set of content of a first type, a first format, or a first presentation;
customizing a second set of content associated with a second part of the particular subject to differ from the first set of content based on the learning preferences of the user, wherein customizing the second set of content comprises selecting more content of the first type, the first format, or the first presentation for the second set of content than is included in the first set of content; and
presenting the second set of content to the user.
